(19) United States
(12) Patent Application Publication
(10) Pub. No.: US 2019/0244463 A1
(43) Pub. Date: Aug. 8, 2019

(54) COMPUTER-IMPLEMENTED METHOD FOR VOTING ON CONTRIBUTIONS

(71) Applicant: Richard NIPPER, Berlin (DE)

(72) Inventor: Richard NIPPER, Berlin (DE)

(21) Appl. No.: 16/300,419

(22) PCT Filed: May 11, 2017
(86) PCT No.: PCT/EP2017/061338

§ 371 Date: Nov. 9, 2018

(30) Foreign Application Priority Data
May 13, 2016 (EP) 16001094.8

(51) Int. Cl. G07C 13/00; G06Q 30/02

(52) U.S. Cl. CPC G07C 13/00; G06Q 30/0279

(57) ABSTRACT

The invention relates to a computer-implemented iterative method for conducting votes by participants on a total number MB of contributions.

The invention relates to a computer-implemented iterative method for conducting votes by participants on a total number MB of contributions.

### FIELD OF APPLICATION AND BACKGROUND OF THE INVENTION

The invention described below is advantageously applied specifically when a large number of people, for instance between 50 and 10 billion, is required to vote on large quantities, for instance between 50 and 10 billion again, of data in response to respectively phrased questions of any type. There may, for instance, be an interest in holding such a vote with respect to photo, film, sound, vector, and/or text files. The data may be technically generated data or measurement data, for instance.

Furthermore, the present invention may be used as a control procedure and/or a control interface for machines whose control and/or programming is performed directly or indirectly by people or by machine-generated instructions. The instructions and/or calibration parameters of machine-generated results obtained by way of the method differ from prior art in terms of their high representativeness for the voters, which without this method can only be obtained stochastically or with great time and effort and are therefore capable of generating a better representation of the opinions within a group of people. A corresponding added value of the invention may for instance be a security, comfort, or utility enhancement.

Current information technologies allow for the accumulation of large quantities of contributions from a large number of people, machines, or measuring instruments that may be located at great physical distances from each other. The contributions may be information of a variety of technical and/or physical origins, such as text, images, sound or other information-based content, and may pertain to any subject, task, question and/or data source.

There is a problem of large numbers of people often not being included in planning, reviewing, or the technical implementation or technical controls, and their respective objectives, needs, ideas, or opinions not being taken into account, because due to a lack of a suitable method it has not been possible take into account all suggestions, ideas, or contributions of all parties concerned without a vote on them taking a very long time, and in that the participation of each individual person would mean that many (between approx. 50 and 10 billion) contributions would have to be examined and evaluated. These might be 50 to 10 billion data sets. In prior art there is no computer or computer network-implemented and/or software-based semi-automated multi-iterative procedure that provides representative voting results of which the representative quality is not limited by the limited—due to the abstinence [sic] of this procedure—number of contributed ballot items from the extensive community (approx. 100 to 10 billion) of voters.

Indeed, most of the methods and systems conceived for recording ballot items allow for a partial accumulation of arbitrary numbers of contributions, but they do not involve procedures that guarantee a structured iterative distribution and processing of data of the type [guaranteed by the method] according to the invention.

In the following, the solution according to the invention is described in the form of a dynamic multi-iterative semi-automatic voting procedure.

### DESCRIPTION OF THE INVENTION

In order to solve the task, a computer-implemented iterative method is provided for conducting votes on a total number MB of contributions by participants, comprising the following steps:
performing a first iteration, comprising
   a) determining a quantity Bi of at least two groups of contributions, wherein the parameter Bi indicates the number of contributions in a contribution group,
   b) forming the at least two contribution groups,
   c) assigning a certain number of participants to the contribution groups, such that in each contribution group, the respective certain number of participants votes on the number Bi of contributions, each participant being able to cast a certain number E of PC votes,
   d) excluding a portion Ti of contributions that will not be part of a next iteration,
   e) identifying the other contributions that will be part of the next iteration,
performing a second iteration, comprising
   f) determining the quantity Bi of at least one group of contributions, wherein the parameter Bi indicates the number of contributions in a contribution group,
   g) forming at least one contribution group,
   h) repeating the steps c) and d), after which the voting procedure is terminated,
      or performing step e) and an additional iteration round according to steps f) through h).

The solution according to the invention comprises in particular a dynamic computer and computer network-implemented method for generating and performing of semi-automated multi-iterative votes on a large number of contributions (approx. 50 to 10 billion.) by a large number of voters (approx. 50 to 10 billion.). The preferably web, database, and/or software-based method and its input interface-based functions advantageously allow users of the method to vote on a large number of contributions or have them voted on without having to assemble at the same location. The method allows for the identification of contributions representing the totality of the participants in the vote, without each participant having to vote on all contributions. The method delivers representative voting results whose quality is not limited by the limited—due to the abstinence [sic] of this procedure—number of contributed ballot items from the extensive community (approx. 50 to 10 billion) of voters. When votes are scheduled in advance, the method allows for obtaining one or multiple representative voting results within just a few minutes.

A method-based vote consists of at least two iterations, the number of iterations being indicated by the index variable i, wherein in preferred embodiments of the invention, the index variable i can be any integer value between i [sic] and e, wherein e is preferably the number all iterations of a vote. For the purposes of the invention, in each iteration, in one or multiple contribution groups, a certain number of voters preferably votes on a certain number of contributions. For the purposes of the invention, the certain number of participants is preferably determined according to Rule 2. For the purposes of the invention, the target size of the contribution groups is preferably determined according to Rule 1. All contribution groups combined preferably comprise the number MBᵢ of contributions not yet voted out in the respective iterations. It is preferred that in an iteration, a specific minimum number of votes is held in each group. In any iteration i, for instance, a certain predetermined percentaged portion Tᵢ (with i=1 to e) of the contributions can be voted out, such that advantageously, fewer contributions remain in the next iteration. As a result, the sizes of the groups and their number may change. An iteration i preferably consists of one or multiple sub-votes ij. The purpose of sub-votes is to collect cast PC votes until the minimum number of PCᵢ votes per contribution group has been reached and the sub-vote is completed. In other words, for the purposes of the invention it is preferred that within the iterations, sub-votes j may be performed in order to collect PC votes, a sub-vote being complete when a minimum number of cast PC votes is reached.

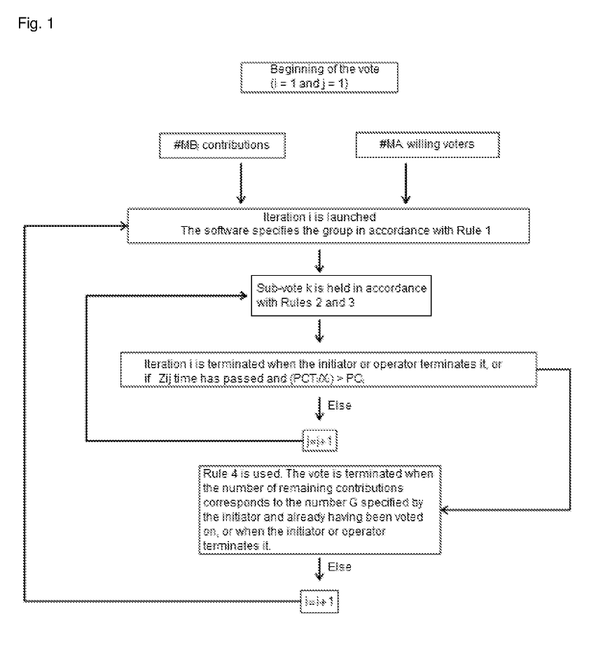

It is preferred that a vote begin with the iteration i=1. The vote may be terminated when only G contributions are left and they have been voted on, or when the operator or the initiator terminates the vote. A schematic flow chart of a preferred embodiment of the method is shown in FIG. 1.

The method preferably comprises the regulation of the development of the sizes of the contribution groups and of the assignment of voters in the course of a vote as described in Rules 1 through 4. Advantageously, the method takes into account the circumstance of non-predictable numbers of participants in each iteration of the vote, as well as the possibility of multiple identical or similar contributions. It is particularly preferred for contributions by participants to be addable to the total number MB of contributions, wherein means are provided to identify and/or combine similar and/or substantially identical contributions. It is particularly preferred for the method to comprise the combining of identical or substantially identical contributions into a [single] contribution. In a preferred embodiment, it is preferred for a selection of the contributions that will be part of the next iteration to be made on the basis of cast PC votes.

In a preferred embodiment of the invention, the method comprises the software-based and computer-implemented user interface required for generating and performing one or multiple votes according to the method in the form of a respective platform. For the purposes of the invention, it is preferred that the “platform” concept refer to an internet and/or Intranet platform, to a mobile application (“app”), and/or to an API interface. In other words: the method preferably comprises providing a software-based and/or computer-implemented user interface as a platform for generating and/or conducting votes according to the method.

Furthermore, the invention preferably also comprises a utilization of the internet as a conglomerate of multiple millions of cross-linked computers and their processors (Central Processing Units, CPUs) worldwide for the voting procedure, such that the participation of millions of people with a connection to the internet or to another computer network in the voting process is advantageously made possible if they have access to a computer connected to the internet, and if they chose to use it and the respective input interface for conveying their contributions and votes in order to exercise influence on the development of the procedure. Moreover, the invention preferably also comprises the equivalent utilization of any intranet structures. For the purposes of the invention, it is preferred for the concept of utilization to mean that on [sic] these structures in particular are used by the voters for casting their vote according to this method or for participating in it by performing other types of actions.

In a preferred embodiment of the invention, the invention further comprises a program interface 1 required for the configuration of the voting parameters by the operator the platform, which for the purposes of the invention it is preferably also referred to as the first program interface. It is therefore preferred for the method to comprise providing a first program interface for the configuration and/or adjustment of voting parameters, the voting parameters either remaining identical or changing during a vote. In this manner, preferably, iterative votes adapted to the character of the questions underlying a vote or of the nature of the ballot item can be generated. Furthermore, it becomes possible to determine via the program interface 1 which parameters relevant to the vote can be determined by the initiator of a vote themselves, and which cannot.

In a preferred embodiment of the invention, the invention comprises a program interface 2, which for the purposes of the invention is preferably also referred to as the second program interface, by way of which data obtained as a result of a vote can be converted directly into machine-interpretable instructions and transmitted to the machine. For the purposes of the invention, it is therefore particularly preferred for the result of the vote to form a data set, and in that the method comprises providing a second program interface for converting this data set into a machine-interpretable instruction and/or for conveying the data set to the machine. In other words, for the purposes of the invention it is preferred that a result of the vote can be issued and/or transmitted to a machine as an instruction. It can also be preferred that these instructions comprise calibration parameters for a machine.

For instance, for the purposes of the invention it may be preferred that the subject of a vote be the spatial-physical design of an object. In this case, the voting result may be the concrete selection of a design, which is then transmitted according to the method, for instance to a 3D printer, which then prints the object according to the voting result. A variety of technical devices and methods are conceivable that could be controlled by a voting procedure based on the present invention. Preferably, this may either be a physical-structural device or a computer-implemented method that may be executed, for instance, on a computer, a computer network, a server, in a cloud, or on [a] mobile device.

Furthermore, the invention preferably also comprises a program interface 3 for other internet platform operators, for the purposes of the invention preferably also referred to as the third program interface or API, which advantageously makes it possible for votes based on the method according to the invention to be published on their own platform. In a further embodiment of the invention, it is therefore preferred that the method comprise providing a third program interface for the publication of votes and/or voting results on other platforms.

In a preferred embodiment, the method may comprise the inclusion of a function that distributes the sending invitations to participate in a vote at time-spaced intervals, for instance, in order to minimize peak loads on the server. In other words, it is preferred for the method to comprise the sending of invitations to participate in a vote at time-spaced intervals in order to minimize peak loads on the server. In a preferred embodiment of the invention, the method comprises providing a private user area for generating and/or managing votes.

Furthermore, for the purposes of the invention, it is also preferably to combine a number of exactly defined willing voters [sic] into a group that during a vote can preferably act as an entity. Thus it is possible, for instance, that various interest groups form themselves in respective groups that preferably vote on the answers and/or comments of the group.

Holding a vote by way of the invention is preferentially done as follows, wherein the following description can be understood as an exemplary embodiment:

The person who wishes to hold a vote, who for the purposes of the invention it is preferably referred to as initiator, registers on a platform, for instance by means of an e-mail address, their real name, another address, and/or by means of the common registration program interfaces of large internet service providers. They may also register via an API interface that is part of the invention and can be integrated on any other website and configure via this interface all or some of the following settings.

The initiator then has the following setting options for setting up the vote, this not being an exhaustive enumeration of expedient setting options. Furthermore, the operator may decide for each setting option whether they wish to make them available to the initiator on this platform, or not.
1. The initiator may phrase and define a title and a description for the vote. Optionally, they may upload a photo or other media content relevant to the vote to the platform server.
2. The initiator can determine whether the vote is private or public. A private vote is only accessible and/or visible on the platform to personally invited or admitted participants. An public vote is preferably visible and accessible to every person registered on the platform.
3. The initiator can determine whether contributors of a contribution to be voted on may themselves participate in the vote, or not.
4. The initiator can determine whether the vote is to be a “voting chain”, or not. For the purposes of the invention, a voting chain preferably designates a serialization of multiple completed votes. This may be expedient, for instance, in case of votes on individual moves in a board game against an artificial Intelligence.
5. The initiator can determine the maximum number of contributions that a single participant may contribute. Optionally, the initiator may be permitted to change this number during the contributions collection phase. In a particularly preferred embodiment of the invention, one contribution per participant is allowed.
6. The initiator may determine whether the contributions that have already been submitted for the vote can be visible to every person on the platform, or not.
7. The initiator may determine what number E of votes a voter may respectively cast in a PC vote via a contribution group, and whether it is permitted to vote multiple times for a certain contribution, or not. For the purposes of the invention, the abbreviation PC stands for per capita, meaning “per person”. For the purposes of the invention, a PC vote preferably describes the participation of a person in a vote by way of casting E votes. The preferred standard setting is E=1.
8. The initiator may determine a minimum number of contributions needed for triggering the automatic beginning of the vote. The initiator can continue changing this value as long as the operator allows.
9. The initiator may determine a minimum number of people registered to vote that is required for starting the voting procedure.
10. The initiator may determine the value Bᵢ at the beginning and in the course of the vote process, this value describing the target number of contributions per contribution group that the individual groups of contributions (contribution groups) should approximate for as much as possible, taking into account the total number of all remaining contributions in iteration i and the most equal distribution of contributions over the contribution groups as possible.
11. For the contribution groups Bᵢⱼ, the initiator may determine the variables PCᵢ, and adjust them in the course of the vote, if necessary, this variable describing the minimum number of required PC votes per contribution group Bᵢⱼ in every iteration i. An adjustment may be expedient, for instance, if due to a change of MAᵢ, the target minimum representativeness of the vote in the individual groups can only be realized by way of a corresponding adjustment of PCᵢ.
12. The initiator may set and adjust time intervals Zᵢⱼ for the individual sub-votes j in the iterations i at the beginning and optionally also in the course of the vote, the time intervals describing how long a sub-vote should continue after its beginning until it terminates. If the operator allows it, this value may also be adjusted in the course of the respective sub-votes.
13. The initiator may set the time intervals Z2ᵢ for the individual iterations, these time intervals describing how long the waiting time for a response from a respective user should be when identifying multiple identical contributions in an iteration i.
14. The initiator may set the marginal value G that describes the number of remaining contributions which, if exceeded or undershot, will cause these contributions to be grouped for the purpose of performing of a final voting iteration.
15. The initiator may set the value s, which represents the value down to which the individual contribution groups should shrink in the course of the vote, not including the iteration for which G was defined.
16. The initiator may determine whether the vote should take place via an API interface. This interface makes it possible to integrate the vote into external platforms.
17. The initiator may set the percentages Tᵢ that preferably describe the percentage of the remaining contributions that will be included after a sub-vote in the next sub-vote. The following applies to Tᵢ: Tᵢ≥(1/Xᵢ)≤1, wherein Xᵢ=number of the contribution groups in iteration i.
18. The initiator may set the tolerance values Tolᵢ, which can be added up to Tᵢ, which may avoid discrimination in case of a tie between multiple contributions with the same number of votes.
19. The initiator may choose whether or not to permit registration after the vote has started of people who only wish to vote but do not wish to submit contributions of their own to the vote. The initiator may withhold or grant such permission at their discretion in the course of the vote.
20. The initiator set the value S, which designates the minimum number of PC votes per contribution group and iteration that must be reached.
21. The initiator may set the values qᵢ, which determine the degree in which the contribution groups are reduced from one iteration to the next.
22. The initiator can determine whether the contributions of such participants who did not participate in a sub-vote should be removed from the vote after the termination of that sub-vote before the contribution selection based on Rule 4.
23. Optionally, the initiator may decide whether the sub-votes in the individual iterations should be done by live or real-time negotiations among the participants in the individual groups, or not.
24. The initiator can determine that the contributions of such participants who did not participate in a sub-vote are removed from the vote after the termination of that sub-vote before the contribution selection based on Rule 4.

For the purposes of the invention, it is preferred that the operator be able to configure or adjust some or all of the settings mentioned in points 1 through 25 at the beginning and in the course of every vote, for instance via the program interface 1.

If PCᵢ is not defined, preferably: PCᵢ=S

If G is not defined, let G=s.

Alternatively, preferred settings and values are described in Table 2.

Preferably, both the operator and the initiator have access to a graphical user interface, which preferably displays in real time how the voting parameters dependent that were not set change as a function of the parameters that were set. With this function, the initiator or operator may respond to changes and modify their settings when undesired constellations occur.

The vote is preferentially held as follows:

If the initiator has used the available setting options, the vote may be announced on the platform, or alternatively, via the API interface on of another internet or Intranet platform.

If the initiator does so, they obtain a URL link that may, for instance, be software-generated, which specifically points to this vote. Furthermore, the initiator may use an automated interface for sending voting invitation e-mails, for instance to e-mail-address that the initiator has entered into the interface. If, for instance, the initiator has set up a private vote, in a preferred embodiment of the invention, they obtain a software-generated password that would be additionally required in order to participate in the vote.

It is preferred that the system comprise a private user area, specifically one that is only accessible to the initiator after their registration on the platform. For the purposes of the invention, it is preferred that the initiator be able to manage their votes in their private user area. There, with the operator's permission, the initiator may adjust one or several of the settings mentioned in items 1 through 23 in the course of the vote. Furthermore, with the operator's permission and if the operator does not do this themselves, the initiator may also terminate the respective sub-votes, for instance manually, by mouse click. The initiator may send e-mail messages to the participant in the vote. Furthermore, the initiator may start the first iteration, for instance manually, by mouse click. The initiator can also observe there how many contributions have already been made, and how many willing voters have already registered to vote. With the operator's permission, the initiator can also remove contributions from the vote here. In particular, the initiator may decide at any time whether after the termination of the ongoing iteration, the remaining contributions MBᵢ are to be grouped into a contribution group in the following iteration. The initiator may determine for every sub-vote, preferably once and in the course of the vote, whether its term should always be Zij or whether it should be extended by the time that was saved in the previous sub-vote due to a possible premature termination by the operator or the initiator.

Additional setting options and overviews are available to the initiator that may, for instance relate to the moderation of a forum pertaining to the vote.

Optionally, the title and the description of the vote are sent to multiple (approx. 10 to 200) assistants, each of whom decides individually whether the vote is in any way offensive. If it should transpire that a certain portion (for instance more than 5% of the users) find the vote offensive, preferably, either the operator is informed, who then decides whether to terminate the publication or not, or alternatively, a respective decision by the assistants themselves suffices to stop the publication of the vote. For the purposes of the invention, assistants are preferred to be such persons and users who have registered as assistance on the platform in the past.

Optionally, the publication of the vote is only permitted after the aforementioned review by the assistants was completed and the previously defined critical portion of feedback reports on offensive content was not exceeded.

For the purposes of the invention, it is preferred that participation in this process requires registration. This may be done via the platform and/or via the API interface, for instance by means of an e-mail address, a real name, and/or via the common API registration interfaces of familiar internet service providers. In case of a private vote, for instance, registration may involve submitting a password, for instance, which had been communicated to willing voters by the initiator in advance, and/or by way of a URL link generated especially for the invited participants and sent to them via e-mail. For the purposes of the invention, a private vote is preferably a vote in which no commercial interests of a company or of an individual person are at issue, but rather the knowledge gain of a natural person or a group of persons who preferably pursue no commercial objectives, neither individually nor as a group. This may, for instance, be a process for deciding on a date for an event, or a naming process.

It is preferred that upon registration, willing voters can select whether they only wish to participate in the vote, or whether they would also like to make a contribution or, if the operator or the initiator permits it, multiple contributions, for instance by way of input via a computer keyboard or by way of a transfer of technically generated data (such as photo, film, sound, or vector files) for being voted on. It is preferred for a participant to be able to declare their withdrawal from participating in a vote at all times, which preferably leads to their no longer being registered to vote.

The willing voter may also select whether their contribution should be listed anonymously, under a pseudonym, or under their real name.

As soon as the vote begins, every person registered for the vote who, for the purposes of the invention, is referred to as participant, will preferably automatically receive an invitation to vote, for instance by e-mail or by another common means of communication, such as an SMS message and/or a push notification, unless they indicated at the time of registration that they were only making a contribution and did not intend to participate in the vote. In every invitation e-mail, the participant has the option to indicate whether they wish to vote promptly. Optionally, they may also indicate that they do not wish to vote at all. Optionally, they may further indicate that they would like to receive a further e-mail reminder. It is preferred that upon every completed sub-vote, the participant automatically receive an invitation for the next sub-vote by e-mail or by other common means of communication, such as an SMS message and/or a push notification.

The PC vote on the contributions in the individual contribution groups may be done, for instance, by way of “check boxes”, in which one can indicate the contributions that one wishes to vote for. It is therefore preferable for voting to be done by marking check boxes, and/or for a participant in a vote to cast no, one, or up to E PC votes for one or multiple contributions. In a PC vote, preferably between zero and E votes can be distributed over one or more contributions. If E was not defined by the operator or by the initiator, either one or no vote can be cast. Optionally, it could be possible to cast between zero and multiple votes. The marking of contributions with one or multiple votes can also be removed again any number of times. The PC vote is only finished when [a] participant has clicked the respective “button” in order to terminate the PC vote, for instance by way of an input device, for instance a computer mouse, thereby confirming their definitive selection. For the purposes of the invention, the term “button” preferably refers to a location shown on a display screen where input can be submitted that is then processed by the data processing devices to which the display screen is preferably connected. The “button” may, for instance, be actuated by an input device such as a computer mouse, or, if the display screen is a touch display screen, by touching the respective location on the touch screen display.

There are many possible methods that are suitable for allowing a voter to conveniently make a selection. The methods exemplarily listed below should therefore be neither understood as preferred nor as exhaustive. The contributions may be presented such that they can be “scrolled”. They may also be “expandable” meaning that only a part of the contributions is displayed and that the entire content of a contribution only expands and becomes visible after being “clicked” or after a “mouse-over” with the input device, for instance the computer mouse. It is conceivable for a participant to have an expedient graphic interface through which the participant can rank contributions in the order of their preference. For instance, they may be able to freely move the contributions around and sort their preferences accordingly. The contributions may be listed one after other. Alternatively, they may be arranged in a matrix. Contributions for which a vote has already been cast can be optically highlighted separately. Contributions that the voter rules out entirely can be removed from the list completely. This can be done by clicking a “buttons” near or close to the contribution, or by another method. The removal of the contribution from the list may be animated in various ways.

For the purposes of the invention it is preferred that after an iteration is completed and a participant is registered on the platform, they have the option to view the voting results of the iteration and of all completed iterations in their group, or alternatively, in all groups. The participant may preferably be informed about this option along with the invitation for participation in the next iteration.

Once the final iteration is completed, the vote is preferably completed. After the completion of the vote, participants may be sent a respective notification. The final result of the vote may either be transmitted directly to program interface 2, or preferably be shown as follows:

The distribution of the votes over the remaining contributions can be visualized on the platform by way of various graphic means. These exemplarily include, without limitation, 2 or 3-dimensional bar and pie charts. With the operator's permission, the initiator may comment on the completed vote in their personal area, which comment may be presented with the voting result. It is further preferred for the platform to comprise a discussion forum, linked to the voting result, in which the result can be further discussed. It is furthermore particularly preferred for all the contributions that were voted on to be ranked according to their results and to be viewable in this ranked form. Depending on whether the vote is public or private, the final voting result may either be seen by all participants or by all users of the internet.

Additional optional advantageous embodiments that do not limit the invention include the possibility for participants to make counter-proposals to contributions for contributions to be open for comments. In an additional alternatives embodiment, after the completion of a sub-vote, the contributions of participants who did not participate in the sub-vote are removed from the vote. For the purposes of the invention it is preferred that the method comprise the following four rules, or respectively, that individual parameters or variables set in the process are determined or calculated based on these rules.

for performing a multi-iterative vote, the following four rules have the following respective purposes:
Rule 1: The variables of the individual contribution groups are determined;
Rule 2: The voters are assigned to the contribution groups;
Rule 3: The sub-votes are organized;
Rule 4: The contributions that are to be included in the respective next iteration are identified.

For the purposes of the invention, it is preferred for all rules not to be understood as limiting factors. The rules preferably indicate exemplary embodiments for the individual aspects of the invention, mentioned in the individual rule titles.

### Rule 1: Determining the Sizes of the Contribution Groups:

MAᵢⱼ preferably indicates describes the number of all participants registered to vote in iteration i before the beginning of the sub-vote j. If the initiator or the operator does not define the variable B₁, B₁ should preferably be within the intervals described in Table 2.

MBᵢ is the number of all contributions at the beginning the iteration i that have not yet been voted out.

The following if-then relationship describes how the values for Bᵢ with i>1 that were not defined by the operator or by the initiator are calculated.

if #MA₁/Y<#MBᵢ,

then Bᵢ=PCᵢ

else

if #MBᵢ≤G,

then Bᵢ=#MBᵢ

else

if B₍ᵢ₋₁₎*(1−T_{(i-1)*}qᵢ)>(PCᵢ*Y*#MBᵢ)/#MAᵢ₁,

then

if Bᵢ=└B₍ᵢ₋₁₎*(1−T_{(i-1)*}qᵢ)┘>s,

then Bᵢ=└B₍ᵢ₋₁₎*(1−T_{(i-1)*}qᵢ)┘

else Bᵢ=s

else

if Bᵢ=└(PCᵢ*Y*#MBᵢ)/#MAᵢ₁┘>s,

then Bᵢ=└(PCᵢ*Y*#MBᵢ)/#MAᵢ₁┘

For the purposes of the invention it is preferred that the L-shaped brackets mean that [what is inside them] is to be rounded up to the nearest integer number.

In every iteration i (in which preferably i=1 to e) of the vote, the number MBᵢ is subdivided by random drawing from MBᵢ in Xᵢ=└#MBᵢ/Bᵢ┘ among preferably equally large groups Bᵢⱼ(wherein j=1 to Xᵢ), varying in size by no more than V. Any residual part of MBᵢ is uniformly distributed over the groups such that the individual groups vary in size by no more than V. Thus, a number of contributions BGᵢⱼ can be assigned to every contribution group Bᵢⱼ. In other words, the first, second and/or every additional iteration of the vote in a preferred embodiment of the invention comprises the subdivision of a total number MBᵢ of contributions by random drawing among essentially equally large groups that vary in size by no more than V, wherein any possibly remaining contributions from the total number MBᵢ is distributed in a substantially uniform manner, varying by no more than V, over the contribution groups.

The parameter qᵢ preferably has an impact on the degree in which the contribution groups decrease from one iteration to the next. If the initiator or the operator does not define the variables qᵢ, these should preferably be within the intervals described in Table 2.

In a preferred variant, in cases in which resulting group sizes are larger than in a previous iteration, participants are called upon to vote in two different contribution groups. This preferably makes it possible for the required PCᵢ to be realized even in case of group sizes that are smaller than in the previous iteration.

### Rule 2: Assignment of Voters to the Contribution Groups

MAᵢⱼ is preferably the number of all participants registered to vote in iteration i before the beginning of the sub-vote j.

The assignment of the voters to the contribution groups is preferably realized in such a manner that each group Bᵢⱼ(where j=1 to Xᵢ), in which not one more time [sic] was voted than in other groups from Bᵢⱼ, for purposes of the vote on it, in one or multiple successive sub-votes in a random order, an additional voter from MAᵢⱼ is added until the time frame Zᵢⱼ of the respective sub-vote has passed or until the operator or the initiator has terminated the respective sub-vote.

With these assignments, it should furthermore be observed that a voter Qᵢ=┌Y*PCᵢ*Xᵢ/#MAi₁┐ may be assigned to multiple contribution groups in order to case respective PC votes in them. If the initiator or the operator permits it, a voter may also be a person who registered during the already ongoing vote. The factor Y is selected such that the risk that an additional sub-vote is required is kept small. Since it is meant to compensate for the failure rate, this value must be empirically determined, and is preferably between 1 and 2.

In a particularly preferred variant of this rule, the assignment per iteration in done such that the voter is randomly assigned to a contribution group out of a number of the contribution groups to which up to that point fewer voters were assigned than to the other groups, and furthermore, that they comprise the lowest number of contributions on which the participant has already voted. If there is only one such group, this is the group to which the voter is assigned.

Further preferable are all variants of this Rule 2 that have the effect that in the course of a vote conducted according to the rules 1, 3, and 4, a participant would view as many as possible different contributions.

For the purposes of the invention it is preferred that the method not be limited to such votes that feature a uniform distribution of willing voters over the contribution groups. Preferably, the same also applies for the contribution groups Bᵢⱼ. In the individual sub-votes, these may also have different variables (deviation greater than 1), but preferably they should be within the margins defined in Rule 1.

### Rule 3—Sub-Votes

The purpose of the optionally required additional sub-votes ij of an iteration i is to ensure that in every contribution group in an iteration, at least PCᵢ PC votes are held when the initiator or the operator have not determined that the contributions of such participant who did not participate in a sub-vote are excluded from the vote after the termination of the sub-vote and before the contributions selection according to Rule 4.

Preferably, further sub-votes continue to be held until (PCTᵢ/Xᵢ)≥PCᵢ. All participants from MAᵢⱼ are invited to each of the sub-votes.

Optionally, only a fraction from MAᵢⱼ are invited to each of the sub-votes, which, taking into account the failure rate, keeps the probability of the requirement of a third sub-vote very small (approx. <0.0001).

Rule 4: Selection of the Contributions that Will be Part of the Next Iteration

Upon combining any multiple identical contributions at the end of an iteration, preferably, at most the respective ┌Tᵢ*#MBZᵢ┐ contributions out of all remaining contributions make it to the next iteration that jointly received the highest number of votes and which each received at least one vote. This is preferably done in such a manner that the contributions are selected for inclusion in the next iteration in the order of the number of votes received until the number of contributions has reached the value of ┌Tᵢ*#MBZᵢ┐ s, or until no contributions remain that received at least one vote. If the algorithm for this successive selection encounters a set M of contributions with respectively identical votes, preferably, all contributions from the set of M are selected for the next iteration until through the further application of these provisions, more than ┌Tᵢ*#MBZᵢ┐ contributions would be selected for the next iteration. Subsequently, remaining contributions from the set of M are identified and deemed to be selected until the continuation of this process would cause more than ┌Tᵢ*#MBZᵢ┐ contributions to be selected for the next iteration. Optionally, the selection of the remaining contributions is omitted.

If Tolᵢ was defined, what is tested is whether the exhaustion by the margin of tolerance of ┌Tolᵢ*#MBZᵢ┐ by Tolᵢ would lead to a selection of the entire set of M. If this is the case, all contributions from M are selected. If not, Tolᵢ is not used.

Optionally, the percentages Tᵢ are assigned to the tolerance margins Tolᵢ, which can be used for exhausting the remaining amount.

MBZᵢ is the quantity the according of the contributions remaining after the combination of multiple identical contributions at the end of iteration i.

The values Tᵢ were defined or adjusted in advance by the initiator or by the operator or are defined or adjusted by them in the course of the vote. The following preferably applies to Tᵢ: Tᵢ≥(1/Bᵢ)≤1

When for a given value Tᵢ in an iteration i, the expected number of contributions remaining in the subsequent iteration is less than G, then preferably Tᵢ=G/#MBᵢ.

In an optional variant, the voters themselves should be permitted after each completed iteration to decide which contributions should move forward to the next iteration, and which should not. For these purposes, the voting results are presented to the participants or just to some of the participants in the groups in such a manner that the distribution of the votes, but not the content of the contributions that received them, can be seen. Furthermore, no participant should see the results of the group in which they themselves had just voted. Next, every participant should provide a numeric value indicating how many of the contributions, in the order of votes received, should move forward to the next iteration. The most commonly provided numeric value would then serve as a parameter in the procedure.

### Identification of Multiple Identical and Similar Contributions:

In order to prevent participant votes to be distributed over multiple identical contributions, every newly created contribution is compared by an aspect of the method with previously created contributions. If the method identifies contributions that are identical in terms of their content, for instance in text, digital format, image, and/or sound, they are combined before the beginning of the first iteration into a single to a contribution. Optionally, the participants who made these contributions may be informed. The contribution will be identified in the names of the contributors who decided against anonymous participation.

Voters are preferably advised in every sub-vote to mark multiple identical-seeming or very similar contributions. For the purposes of the invention it is preferred that a solution be provided that allows for the marking of such contributions. This may for instance be done by selecting them via “check boxes”.

For the purposes of the invention it is preferred that the method identify contributions that were marked multiple times, and that after the completion of the last sub-vote of an iteration, preferably, the persons who made the respective contributions be automatically informed, for instance by e-mail or by any other means of communication, such as push notifications or SMS messages, about the fact that their contributions were identified as available multiple times. The contributions are shown to them.

The respective persons are then asked to indicate in their user area on the platform or by means of an e-mail-interface which contributions might be merged with their own contributions, which may not, and/or what should be the umbrella term for the combination.

For contributions for which there is a consensus about the merger, the text that was selected most frequently by the affected participants is defined as the summarizing and therefore sole remaining text of the contribution. If there is no unambiguous majority for of summarizing text, the software program decides by way of a random draw from among the texts with the same number of votes.

Optionally, the recipients should be given the possibility to rephrase their contributions in order to differentiate them more clearly from similar contributions.

Optionally, it should make no difference for the decision of the recipients which text exactly is selected for the contribution.

Optionally, or in case that the affected participants do not respond within the time frame Z2, either the initiator or the operator decides which contributions are combined or not. For the purposes of the invention it is preferred that the time frame Z2 can be determined by the operator, and that it be within a preferred range between 1 and 24 hours, particularly preferred between 1 and 6 hours.

The affected participants may, for instance, be informed in advance by e-mail, via the program interface 1, and/or via a different form of notification about the fact that they are to review the contributions and make a respective an decision. Once the decision is made, the persons whose contributions are affected by the decision are informed about it, for instance by e-mail or via a different communication route. The merger is preferably realized between two sub-votes and/or in before the selection of the contributions that will become part of the next iteration. The values MBᵢ are reduced correspondingly. Preferably, only contributions from the same contribution group are combined.

### API Interface:

The API interface, which for the purposes of the invention is preferably also referred to as program interface 3 or as third program interface, is preferably a service for other internet platform operators that allows them to publish based on the method according to the invention on the own platform. In order to allow for embedding the API interface in the own platform, respective users of the API interface receive detailed documentation about the interface functions and their parameters. The interface allows for the publication of the title and the description of the vote on their own platform and provides willing voters with access to information about the procedure and the technicalities of the vote. It further provides willing voters with a possibility to register for the vote in order to participate.

### The Program Interface 1

It is preferred that the operator be able to use the program interface 1 to define or adjust parameters relevant to the vote before or in the course of a vote.

Using the program interface 1, the operator may furthermore determine which parameters relevant to the vote the initiator of a vote may define, and which they may not.

Depending on the composition of the totality of willing voters, on how heterogeneous the spectrum of opinions expressed in a vote is expected to be, on the effort that willing voters are ready to make, and/or the degree of reliability by which the most favored contributions are to be identified, different voting parameters (Bᵢ, PCᵢ, Tᵢ, s, qᵢ, E, G, Zᵢⱼ, Z2ᵢ) may be expedient.

It is also preferred for the parameters to be adjusted depending on the development of the voting procedure.

Preferably, the Program Interface 1 may also be used for sensitivity analysis and for deriving concrete if-then relationships for the definition of the parameters.

For these purposes it is preferred for the Program Interface 1 to be available to the operator so as to allow them to define and/or adjust the parameters in an ongoing manner.

### The Program Interface 2:

The Program Interface 2 preferably serves for the fast and automatic transmission of the data obtained from the votes to such machines for whose instruction, control, and/or programming the vote was created.

With this interface, the data obtained is preferably converted into a data format that can be interpreted by the recipient machine in accordance with the respective program interface of the affected machine and transmitted to it. This avoids the situation that after the completion of a vote, additional time would pass until the voting results are converted into machine-interpretable data as necessary in order to obtain the desired mechanical product, for instance a 3D print, a telescope movement, a TV transmission, or a monitor image, thus possibly affecting the success realizing a goal.

For the purposes of the invention it is preferred that the method comprise iterative votes with two or more iterations. It is further preferred that in a preferred embodiment of the method, based on the values and the parameter intervals listed in Table 2 and the combinations of values and intervals allowed by the logic of the method, is performed [sic]. The method comprises in particular a computer-implemented multi-iterative voting procedure based on a combination of an arbitrary number of rules from Rule 1 through 4.

Furthermore, the method is based on all the rules corresponding in terms of their purpose to rules 1 to 4. This utilitarian specificity implies that their application preferably leads to identical, and more preferably to approximately identical, results.

It is further preferred that the method comprise user functions allowing for the creation of procedure-based votes. In a preferred embodiment, the method comprises the API interface for integrating the computer-implemented iterative voting procedure [into third-party platforms]. It is also preferred that the method allow for iterative voting based on the rules 1 through 4. In a preferred embodiment of the invention, the method comprises procedures for identifying and eliminating multiple identical contributions and/or for generating the interface required for performing the method according to the invention in the form of the platform. In a preferred embodiment of the invention, the total number MB of contributions is greater than 100, more preferably greater than 1000 and most preferably greater than 10,000, and/or the number of participants is greater than 100, preferably greater than 500, and most preferably greater than 1000. For the purposes of the invention it is particularly preferred for the number MB to be [within] a preferred range of 5, 50, 100, 200, 500, 1,000, 5,000, 10,000, 50,000, 100,000, 500,000, 1,000,000, 10,000,000, 100,000,000, 1,000,000,000, or 10,000,000,000 contributions.

With the size of MB, the likelihood increases of a particularly exceptional and/or solution-oriented contribution, as does the portion of the population affected by a respective task or question [involved in creating a solution]. At the same time, there is an increase of the comparative advantage gained by the time saved in the contributions selection due to the application of the method.

### Technical Effects and Advantages of the Method

The technical effects and advantages of the method are that in case of large numbers of contributions, individual voters are not required to review and evaluate all contributions (several hundreds or even thousands) and do not have to meet with all other voters at a single location. A further advantage is that the method advantageously delivers representative voting results whose quality is not limited by the limited—due to the abstinence [sic] of this procedure—number of contributed ballot items from the extensive community (approx. 100 to 10 billion) of voters. Furthermore, due to short times Zᵢⱼ, voting results can be obtained within fewer minutes when the votes are scheduled in advance.

Due to the iterative embodiment of the voting procedure, in view of the significant reduction of the contributions that have to be reviewed, out of the total number of contributions, the contributions can be identified that best represent the totality of all voters with a quality not described in prior art.

The method according to the present invention distinguishes itself among other things by its inherent functional improvement as compared to prior art in the sense that in particular through the practicable balance between the effort required from every individual voter and the degree of representativeness of the vote, decisions are made based on stated voter preferences.

The possible applications of the voting system and method in the meaning of the invention are very extensive. Possible application examples are listed below, without limiting the invention to these:
1) Large collectives of people can select highly representative proposed or possible instructions, ideas, or services among a series or group of options select and decide within minutes on mechanical controls and/or instructions or make other policy-making decisions.
   a. For example, the transmission of the flight or orientation coordinates of a satellite.
   b. Orientation coordinates of a telescope.
   c. Programming and data input into mainframe computers and/or computer networks
   d. Transmission of instructions for traffic control systems.
   e. Data input for the product design of any mechanically producible products.
2) Communities may ask citizens to submit their own contributions on certain subjects and to vote on them.
3) Schools may allow students to vote on all contributions on a certain topic.
4) Comments in internet portals, often accumulating in the tens of thousands, can be ranked and sorted by the users by popularity according to the proposed method.
5) Corporations may hold competitions for the best innovations.
6) The most popular photos among many thousands of submissions can be identified.

In the following, the method is described based on an exemplary application:

Mr. W., a traffic engineer, is commissioned by the city of Munich to restructure and improve the metropolitan traffic control system and traffic flow. His target is to increase the average speed of mobility in the city while simultaneously reducing the risk of accidents. Since popular approval of the traffic regulation system and the willingness to comply with respective regulations, along with drawing on the citizenry's experiences in traffic and implementation of their suggestions are success factors for achieving the target, Mr. W. is looking for a way to establish a traffic control system that has the approval of a significant part of the metropolitan population of Munich and takes into account their experiences and desires. Mr. W. therefore intends to use the method according to the invention and to implement the result in the traffic control system. He registers on the platform.

He formulates the title for the vote: “Including the Sovereign Population of Munich in Metropolitan Traffic Control”. He writes a text that explains the purpose of applying this method, and that invited participants can contribute to the improvement of the traffic control system by offering their opinions and suggestions. He uploads a photo of the city to the platform. He defines that the vote is to be private. He defines that people submitting a contribution may also participate in the vote. He defines that it this is a one-time vote and not a voting chain. He defines that contributions made should be visible to participants. He defines that participants may submit only one contribution. He determines the following values:

### B₁=10

PCᵢ=S=30 for i=1 to e

### S=5

### G=10

### E=1

He has no additional settings available to him due to the specifications of the operator.

The operator defines that a contribution is not removed from the vote if its author declined to participate in a sub-vote.

The operator has specified the following voting parameters that apply to all iterations:

Zᵢⱼ=24 where i=1 to e and j=1 to ∞
Z2ᵢ=6 where i=1 to e
q₁=0, q₂=1
qᵢ=0.5 for i=3 to e

### T₁=0.5

### T₂=0.4

Tᵢ=0.2 for i=3 to e

### Y=1.2

Mr. W. publishes the vote. In his personal area, he uses the invitation interface and enters e-mail addresses of Munich residents known to him. The respective recipients instantaneously receive an invitation to the vote with an explanation as to what the vote is about, a URL link to the vote, and a password for the vote. He sends out further invitations by mail.

Mr. W. waits for a while to see how many persons are registering for the vote. He can see this in his personal area.

Participants who logged in with the password register in the platform, and some of them submit contributions for the vote of their own. After two week [sic], Mr. W. finds 367,469 contributions were made and 571,230 participants wish to participate in the vote. In his personal area, he adjusts the maximum number of contributions per participant. 12,045 additional contributions are received.

Mr. W. starts the vote.
The 1^{st} iteration begins:

### #MA₁₁=571,230

### #MB₁=379,514

All 571,230 willing voters receive an invitation to vote.
Rule 1 creates the following values:
GB₁ⱼ=10 where j=1 to 37,947 and GB₁ⱼ=11 where j=37,948 to 37,951

After 24 hours, 480,344 persons have participated in the first sub-vote of iteration 1, and in accordance with Rule 2 they voted one time in each of Q₁=3 different contribution groups. Therefore, PCT₁=1,441,032.

A total of 9,697 identical contributions are reported. These are merged into 4,843 contributions. Therefore, #MBZi=374,660. Subsequently, according to Rule 4, 187,330 contributions are identified that were selected for iteration 2.

Before the first sub-vote of the second iteration, 23,476 participants deregistered from the vote, and 34,454 new persons registered themselves.

The 2^{nd} iteration begins:

### #MA₂₁=582,208

### #MB₂=187,330

All 582,208 willing voters receive an invitation to vote.
Rule 1 creates the following values:
GB₂ⱼ=10 where j=1 to 18.733

After 24 hours, 506,520 persons have participated in the first sub-vote of iteration 2, and in accordance with Rule 2 they voted one time in each of Q₂=2 different contribution groups.

A total of 4,394 identical contributions are reported. These are merged into 2,191 contributions. Therefore, #MBZ₂=185,127. Subsequently, according to Rule 4, 74,051 contributions are identified that were selected for iteration 3. Before the first sub-vote of the third iteration, 7,476 participants deregistered from the vote, and 61,454 new persons registered themselves.

The 3^{rd} iteration begins:

### #MA₃₁=636,186

### #MB₃=74,051

All 636,186 willing voters receive an invitation to vote.
Rule 1 creates the following values:
GB₃ⱼ=6 where j=1 to 12,336 and GB₃ⱼ=7 where j=12,337 to 12,341

After 24 hours, 529,306 persons have participated in the first sub-vote of iteration 3, and in accordance with Rule 2 they voted once in one respective contribution group.

A total of 2,324 identical contributions are reported. These are merged into 1,162 contributions. Therefore, #MBZ₃=72,889. Subsequently, according to Rule 4, 14,578 contributions are identified that were selected for iteration 4.

Before the first sub-vote of the fourth iteration, 1,476 participants deregistered from the vote, and 21,454 new persons registered themselves.

The 4^{th} iteration begins:

### #MA₄₁=656,164

### #MB₄=14,578

All 656,164 willing voters receive an invitation to vote.
Rule 1 creates the following values:
GB₄ⱼ=5 where j=1 to 2,912 and GB₄ⱼ=6 where j=2,913 to 2,915

After 24 hours, 492,123 persons have participated in the first sub-vote of iteration 4, and in accordance with Rule 2 they voted once in one respective contribution group.

A total of 878 identical contributions are reported. These are merged into 439 contributions. Therefore, #MBZ₄=14,139. Subsequently, according to Rule 4, 2,828 contributions are identified that were selected for iteration 5.

Before the first sub-vote of the fourth [sic] iteration, 821 participants deregistered from the vote, and 8,454 new persons registered themselves.

The 5^{th} iteration begins:

### #MA₅₁=663,797

### #MB₅=2,828

All 663,797 willing voters receive an invitation to vote.
Rule 1 creates the following values:
GB₅ⱼ=5 where j=1 to 565 and GB₅ⱼ=6 where j=566 to 568

After 24 hours, 630,607 persons have participated in the first sub-vote of iteration 5, and in accordance with Rule 2 they voted once in one respective contribution group.

A total of 120 identical contributions are reported. These are merged into 60 contributions. Therefore, #MBZ₅=2,768. Subsequently, according to Rule 4, 554 contributions are identified that were selected for iteration 6.

Before the first sub-vote of the fourth [sic] iteration, 345 participants deregistered from the vote, and 90,564 new persons registered themselves.

The 6^{th} iteration begins:

### #MA₆₁=754,016

### #MB₆=554

All 754,016 willing voters receive an invitation to vote.
Rule 1 creates the following values:
GB₆ⱼ=5 where j=1 to 106 and GB₆ⱼ=6 where j=107 to 110

After 24 hours, 723,453 persons have participated in the first sub-vote of iteration 6, and in accordance with Rule 2 they voted once in one respective contribution group.

A total of 30 identical contributions are reported. These are merged into 15 contributions. Therefore, #MBZ₆=539. Subsequently, according to Rule 4, 108 contributions are identified that were selected for iteration 6.

Before the first sub-vote of the fourth [sic] iteration, 640 participants deregistered from the vote, and 120,534 new persons registered themselves.

The 7^{th} iteration begins:

### #MA₇₁=873,910

### #MB₇=108

All 873,910 willing voters receive an invitation to vote.
Rule 1 creates the following values:
GB₇ⱼ=5 where j=1 to 19 and GB₇ⱼ=6 where j=20 to 21

After 24 hours, 737,988 persons have participated in the first sub-vote of iteration 7, and in accordance with Rule 2 they voted once in one respective contribution group.

A total of 6 identical contributions are reported. These are merged into 3 contributions. Therefore, #MBZ₇=105. Subsequently, according to Rule 4, 21 contributions are identified that were selected for iteration 8.

Before the first sub-vote of the eighth iteration, 2,323 participants deregistered from the vote, and 56,647 new persons registered themselves.

The 8^{th} iteration begins:

### #MA₈₁=928,234

### #MB₈=21

All 928,234 willing voters receive an invitation to vote.
Rule 1 creates the following values:
GB₈ⱼ=5 where j=1 to 3 and GB_{8/4}=6

After 24 hours, 891,503 persons have participated in the first sub-vote of iteration 8, and in accordance with Rule 2 they voted once in one respective contribution group.

A total of 6 identical contributions are reported. These are merged into 3 contributions. Therefore, #MBZ₆=18. Subsequently, according to Rule 4, 10 contributions are identified that were selected for iteration 9.

Before the first sub-vote of the ninth iteration, 10,435 participants deregistered from the vote, and 48,346 new persons registered themselves.

The 9^{th} iteration begins:

### #MA₉₁=966,145

### #MB₉=10

All 966,145 willing voters receive an invitation to vote.
Rule 1 creates the following values:

### GB_{9/1}=10

After 24 hours, 941,503 persons have participated in the first sub-vote of iteration 9, and in accordance with Rule 2 they voted once in one respective contribution group.

A total of 4 identical contributions are reported. These are merged into 2 contributions.

The vote is completed. The process took 11 days and 6 hours and produced 8 contributions out of a total of 379,514 contributions, voted on in the final iteration by 941,503 participants. Based on the respective percentaged vote distribution, the outcome can suffice as an instruction for the traffic control system and its material design.

Table 1 summarizes the development of the characteristic for the given exemplary procedure.

| Iteration | MAᵢ₁ | MBᵢ | Bᵢ | Xᵢ | Qᵢ | ABᵢ |
|---|---|---|---|---|---|---|
| 1 | 571230 | 379514 | 10 | 37951 | 3 | 45 |
| 2 | 582208 | 187330 | 10 | 18733 | 2 | 62 |
| 3 | 636186 | 74051 | 6 | 12341 | 1 | 51 |
| 4 | 656164 | 14578 | 5 | 2915 | 1 | 225 |
| 5 | 663797 | 2828 | 5 | 568 | 1 | 1168 |
| 6 | 754016 | 554 | 5 | 110 | 1 | 6854 |
| 7 | 873910 | 108 | 5 | 21 | 1 | 41614 |
| 8 | 928234 | 21 | 5 | 4 | 1 | 232058 |
| 9 | 966145 | 10 | 10 | 1 | 1 | 966145 |

With respect to iteration 5, for instance, the table states as follows:

In iteration 5, out of MA_{5.1}=663,797 willing voters, at least AB₅=1,168 participants voted one time respectively in Q₅=1 groups out of a total of X₅=568 groups on at least B₅=5 out of 2,828 contributions.

Definitions: the following explanations indicate how the concepts used here should preferably be understood for the purposes of the invention:
Contribution: a “contribution” is every contributed ballot item in any form, of physical and/or technical and/or human origin (for instance: text, images, sounds, videos, data).
Contribution group: a “contribution group” preferably describes a part the deselected [sic] contributions, or all deselected contributions, to which for the purpose of voting a certain number of PC votes is assigned.
Operator: the operator is preferably the person who operates and administers the platform on which the software-based method is implemented.
Button: an operating element on the graphical user interface.
Input interface: a medium for transmitting data, for instance on a computer (keyboard, camera, microphone, mouse, etc.).
Interface: a graphical user interface.
PC vote: a “PC vote” (per capita) preferably describes a vote by a person in a sub-vote in a contribution group, involving the casting of E votes.
Vote: a vote preferably describes a selection by a participant in a sub-vote of an iteration that is cast for a respective contribution in a contribution group.
Platform: the “platform” concept preferably describes an internet or an Intranet platform.
Participant: a person registered for the vote.
Sub-vote: a sub-vote describes a vote in an iteration. An iteration preferably consists of multiple, but at least one, sub-vote.
Voter: preferably a person who registered on the platform for the purpose of an impending vote in an iteration and has not yet cast all the votes requested from them in the active sub-vote of the iteration in one or multiple contribution groups
Failure rate: the failure rate preferably describes the portion of persons invited to a sub-vote who have not voted by the end of the respective sub-vote as a percentage of the totality of all persons invited to a sub-vote.

List of the parameters and variables used in the context of the present invention:

### Parameters Pertaining to the Contribution Groups:

MBᵢ=the number of remaining contributions at the beginning of the iteration i
MBZᵢ=the number of remaining contributions after the merger of identical contributions in iteration i
Xᵢ=the number of contribution groups in iteration i
Bᵢⱼ=the designation of the contribution group j in iteration i
GBᵢⱼ=the number of contributions in the contribution group Bᵢⱼ
Bᵢ=the value description the number of contributions that the contribution groups in iteration i should approximate, at a given MBᵢ and a maximum comparative deviation of V.
G=marginal value for the number of remaining contributions which, if undershot, should be combined in a group.
s=The size to which the individual contribution groups should shrink in the course of the vote in the final iteration.
Tᵢ=percentage stating the percentage [sic] of the remaining contributions that is to move forward to a next iteration i+1 after the completion of iteration i. The following applies to Tᵢ:

Tᵢ≥(1/Xᵢ)<1

Tolᵢ=tolerance value that can be added to Ti if this can avoid discrimination among contributions with identical numbers of votes.
V=the maximum number of contributions by which the sizes of the contributions may differ in any iteration.
qᵢ=factor that regulates to what extent the percentage Tᵢ affects the reduction of the contribution group size from iteration i to iteration (i+1).

### Parameters Pertaining to the Voters:

MAᵢⱼ=the number of voters registered in sub-vote j of iteration i.
ABᵢ=the smallest number of PC votes in a contribution group in an iteration i
PCᵢ=a variable defined by the operator or the initiator describing the minimum number of PC votes per contribution group Bᵢⱼ in iteration i
TO=tolerance value as a percentage of PCᵢ by which the value of PCᵢ may deviate downward at the most.
PCTᵢ=the number of all PC votes in iteration i by the completion of the final sub-vote
S=the minimum number of PC votes per contribution group that must be reached before it can be reduced in the next iteration.
E=the number of admissible votes per participant, per sub-vote, and per contribution
Qᵢ=┌Y·PCᵢ*Xᵢ/#MAᵢ₁┘

### Additional Parameters:

I=Control variable describing the i^{th} iteration
e=the number of all iterations of a vote
Zᵢⱼ=fixed time interval in hours (0 to 100,000)
Z2ᵢ=fixed time interval in hours (0 to 100,000))
Y=buffer size (1 to 2)

The invention is further described based on the following FIGURES; The FIGURE shows as follows:

FIG. 1 A schematic representation of a preferred flow of a vote.

FIG. 1 shows a possible flow of a preferred embodiment of the method. At the beginning of the vote, the parameters i and j may be selected such, for instance, that they respectively amount to 1. At its beginning, for instance, the vote may involve #MBᵢ contributions and #MAᵢ₁ willing voters. Preferably, iteration i is then started, the participants being subdivided into groups, for instance by a software. This may be done, for instance, by application of Rule 1. It may further be preferable that a sub-vote j is held which may, for instance, take place according to Rules 2 and 3.

Preferably, iteration i is terminated when the initiator or an operator terminates the iteration or when a time Zᵢⱼ has passed and the condition (PCTi/Xi)>PCi was met. If this is not the case is, the next sub-vote is held, and j=j+1.

After the end of an iteration, for instance, Rule 4 may be applied. The vote is preferably completed when the number of remaining contributions reaches the number of G specified by the initiator, and if these have already been voted on. The vote may also be terminated by the initiator or the operator. If the vote is not terminated, preferably, an additional iteration is performed, and i=i+1.

TABLE 2
Parameter constellations inherent in the method'

| | | particularly | |
|---|---|---|---|
| | preferred | preferred | most preferred |
| B₁ | 2-100 | 2-40 | 4-36 |
| Bᵢ | according to Rule 1 | according to | according to Rule 1 |
| | | Rule 1 | |
| PCᵢ | 2 to ∞ | 5 to ∞ | 10 to ∞ |
| T₁ | 0.25 to 1 | 0.5 to 1 | 0.75 to 1 |
| T₂ | 0.25 to 1 | 0.5 to 1 | 0.75 to 1 |
| Tᵢ | 0 to 1 and ≥ (1/Bᵢ) | 0 to 1 and ≥ (1/Bᵢ) | 0 to 0.5 and ≥ (1/Bᵢ) |
| S | 5 to 1000 | 5 to 80 | 10 to 40 |
| s | 2 to ∞ | 3 to ∞ | 4 to ∞ |
| qᵢ | 0 to 1 | 0.2 to 0.8 | 0.3 to 0.7 |
| Zᵢⱼ | 0 to ∞ | 0 to 200 | 0 to 48 |
| Z2ᵢⱼ | 0 to ∞ | 0 to 200 | 0 to 48 |
| i | 2 to ∞ | 3 to ∞ | 4 to ∞ |
| Y | 1 to 2 | 1 to 1.6 | empirically determined |
| G | 5 to 15 | 5 to 20 | 5 to 30 |
| E | 1 to 20 | 1 to 10 | 1 to 5 |
| V | 1-30 | 1-15 | 1-5 |

1. A computer-implemented iterative method for conducting votes on a total number of MBs of contributions by participants, comprising the following steps:
performing a first iteration, comprising
a) determining a quantity Bi of at least two groups of contributions, wherein the parameter Bi indicates the number of contributions in a contribution group,
b) forming the at least two contribution groups,
c) assigning a certain number of participants to the contribution groups, such that in each contribution group, the respective certain number of participants votes on the number Bi of contributions, every participant being able to cast a certain number E of PC votes,
d) excluding a portion Tᵢ of contributions that will not be part of a next iteration,
e) identifying the other contributions that will be part of the next iteration,
performing a second iteration, comprising
f) determining the quantity Bi of at least one group of contributions, wherein the parameter Bi indicates the number of contributions in a contribution group,
g) forming at least one contribution group,
h) repeating the steps c) and d), after which the voting procedure is terminated,
or performing step e) and an additional iteration round according to steps f) through h).

2. A computer-implemented iterative method as claimed in claim 1,
characterized in that
the method comprises combining identical or substantially identical contributions into a [single] contribution.

3. A computer-implemented iterative method as claimed in claim 1 and/or 2,
characterized in that
a selection of the contributions that will be part of the next iteration is made on the basis of cast PC votes.

4. A computer-implemented iterative method as claimed in one or multiple of the preceding claims,
characterized in that
within the iterations, sub-votes j may be performed in order to collect PC votes, a sub-vote being complete when a minimum number of cast PC votes is reached.

5. A computer-implemented iterative method as claimed in one or multiple of the preceding claims,
characterized in that
contributions by participants can be added to the total number MB of contributions, wherein means are provided to identify and/or combine similar and/or substantially identical contributions.

6. A computer-implemented iterative method as claimed in one or multiple of the preceding claims,
characterized in that
the method comprises providing a software-based and/or computer-implemented user interface as a platform for generating and/or conducting votes according to the method.

7. A computer-implemented iterative method as claimed in one or multiple of the preceding claims,
characterized in that
the method comprises providing a first program interface for the configuration and/or adjustment of voting parameters, the voting parameters either remaining identical or changing during a vote.

8. A computer-implemented iterative method as claimed in one or multiple of the preceding claims,
characterized in that
a result of the vote can be issued and/or transmitted to a machine as an instruction.

9. A computer-implemented iterative method as claimed in one or multiple of the preceding claims,
characterized in that
the result of the vote forms a data set, and in that the method comprises providing a second program interface for converting this data set into a machine-interpretable instruction and/or for conveying the data set to the machine.

10. A computer-implemented iterative method as claimed in one or multiple of the preceding claims,
characterized in that
the method comprises providing a third program interface for participation in votes according to the method on other platforms.

11. A computer-implemented iterative method as claimed in one or multiple of the preceding claims,
characterized in that
the method comprises providing a graphical user interface for representing the voting parameters, their changes, and/or the voting results.

12. A computer-implemented iterative method as claimed in one or multiple of the preceding claims,
characterized in that
the method process comprises providing a private user area for generating and/or managing votes.

13. A computer-implemented iterative method as claimed in one or multiple of the preceding claims,
characterized in that
voting is done by marking check boxes takes place and/or by a participant in a vote casting no, one, or up to E PC votes for one or multiple contributions.

14. A computer-implemented iterative method as claimed in one or multiple of the preceding claims,
characterized in that
the first, second, and/or every additional iteration of the vote comprises the division of a total number MBᵢ of contributions by randomly drawing substantially equally large group with a maximum size differences of V, the remaining contributions from the total number MBᵢ being distributed in a substantially uniform manner over the contribution groups.

15. A computer-implemented iterative method as claimed in one or multiple of the preceding claims,
characterized in that
the total number MB of contributions is greater than 100, preferably greater than 1000 and most preferably greater than 10000.

16. A computer-implemented iterative method as claimed in one or multiple of the preceding claims,
characterized in that
the number of participants is greater than 100, preferably greater than 500, and most preferably greater than 1000.

17. A computer-implemented iterative method as claimed in one or multiple of the preceding claims,
characterized in that
the method comprises sending of invitations to participate in a vote at time-spaced intervals in order to minimize peak loads on the server.

18. A computer-implemented iterative method as claimed in one or multiple of the preceding claims,
characterized in that
the number of the contributions in a contribution group varies at the most by the value V.
